(19) United States
(12) Patent Application Publication
(10) Pub. No.: US 2026/0281917 A1
(43) Pub. Date: Sep. 17, 2026

(54) FLEXIBLE POWER CAPABILITY CHANGE REPORTING BY POWER HEADROOM REPORT (PHR)

(71) Applicant: Telefonaktiebolaget LM Ericsson (publ), Stockholm (SE)

(72) Inventors: Maomao CHEN LARSSON, Lund (SE); Christian BERGLJUNG, Lund (SE); Robert Mark HARRISON, Grapevine, TX (US)

(21) Appl. No.: 19/167,202

(22) PCT Filed: Mar. 28, 2024
(86) PCT No.: PCT/EP2024/058706

§ 371 Date: Sep. 19, 2025

Related U.S. Application Data
(60) Provisional application No. 63/493,201, filed on Mar. 30, 2023.

(51) Int. Cl. H04W 52/36

(52) U.S. Cl. CPC H04W 52/365

(57) ABSTRACT

A method, system and apparatus are disclosed. In some embodiments, a wireless device is configured to determine a power capability modification, and transmit a power headroom report, PHR. The PHR quantifies the power capability modification for a serving cell based on a first field and a second field included in the PHR.

### TECHNICAL FIELD

The present disclosure relates to wireless communications, and in particular, to power capability change reporting.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### Power Class Fallback Reporting by Power Headroom Report (PHR)

Report power class change in PHR is briefly described below.

The wireless device is connected to a network node that has configured a PHR for a cell group consisting of one or more serving cells. For an Evolved-Universal Terrestrial Radio Access New Radio-Dual Connectivity (EN-DC) or NR Uplink (UL) Carrier Aggregation (CA) configuration a multi-entry PHR is configured, otherwise a single-entry PHR is configured. When the network node configures powerClassFallBackReporting for the PHR and the purpose of power-class fallback reporting, a threshold phr-Tx-BandPowerClassChange dB is configured for one or more serving cells and phr-Tx-PowerClassChange for a band combination is configured. Absence of powerClassFallBackReporting means that power-class reporting is not configured.

A PHR is triggered whenever the wireless device is changing the power class by a ΔP_{powerclass} of at least phr-Tx-BandPowerClassChange dB for a serving cell or by a ΔP_{powerclass,CA} of at least phr-Tx-PowerClassChange for a band combination in the configured maximum output power for the wireless device.

FIG. 1 and FIG. 2 are diagrams of examples of the conditions to trigger the PHR reporting by the power class change where, in FIG. 1, the power class is changed from a high power class to a low power class to trigger PHR, and, in FIG. 2, a power class is changed from a low-power class to a high-power class to trigger PHR.

### Power Management Maximum Power Reduction (P-MPR) as Wireless Device Power-Capability Fallback

Some device implementations use the P-MPR to modify the power capability for a serving cell for compliance with Specific Absorption Rate (SAR) and Minimum Permissible Exposure (MPE) exposure limits similarly to a power-class change by ΔP_{power class}, sometimes referred to as a power class fallback. Given the time averaging used for exposure measurements (order of seconds or minutes) it is expected that the P-MPR due to high-power transmissions with large UL duty cycles is slowly changing similarly to the power class change ΔP_{power class}.

Power reduction by P-MPR is only indicated with a certain range for FR1 or FR2 in 3GPP specification but how much values should be applied to P-MPR is not specified in 3GPP specification. (Hence power reduction by P-MPR can be a proprietary configuration up to UE implementation). P-MPR power reduction can also be used for mitigation exposure compliance due to, e.g.,
proximity detection (operation of the wireless device close to the body of the user)
transmission on another uncoordinated radio access technology (RAT) not controlled by the network node and connection for which the power class/capability is relevant. Hence, power reduction by P-MPR is not only for power class (capability) fallback due to high-power transmissions with large duty cycles. The network node is not aware of the reason for the P-MPR power reduction being applied even if it is included in the reported maximum output power, P_{CMAX,f,c}(i). The P-MPRc applied for a serving cell c may or may not override other power reductions like MPRc and A-MPRc for which the maximum allowance (i.e., maximum allowed value) is specified in, for example, 3GPP standards such as 3GPP Technical Specification 38.101-1 for a single serving cell in FR1, according to:

The configured maximum output power P_{CMAX,f,c} is set within the following bounds:

P_{CMAX_L,f,c}≤P_{CMAX,f,c}≤P_{CMAX_H,f,c} with

$${P}_{CMAX \_ L , f , c} = MIN \{ {P}_{EMAX , c} - Δ {T}_{C , c} , \text{} ( {P}_{PowerClass} - Δ {P}_{PowerClass} ) - MAX \text{} ( MAX \text{} ( \text{} {MPR}_{c} + Δ \text{} {MPR}_{c} , A - {MPR}_{c} ) + Δ {T}_{IB , c} + Δ {T}_{C , c} + Δ {T}_{RxSRS} , P - {MPR}_{c} ) \}$$

$${P}_{CMAX \_ H , f , c} = MIN \{ {P}_{EMAX , c} , {P}_{PowerClass} - Δ {P}_{PowerClass} \}$$

where the lower bound may or may not be limited by P-MPR_{c}. The P_{CMAX,f,c}(i) included in the PHR and governing the PH reported is based on the actual power reduction by the wireless device up to the maximum allowed by MPR and A-MPR.

The use of P-MPR for exposure mitigation due to high-power transmissions with large UL duty cycles is sometimes referred to as the “P-MPR method” and applies to uplink serving cells of an uplink band combinations. The power capability of the band combination is not modified by the P-MPR according to the UE capability standardized in 3GPP such as in 3GPP TS 38.306, 38.306 v17.2.0 as noted below

| | | | | |
|---|---|---|---|---|
| maxUplinkDutyCycle-interBandCA-PC2-r17 | BC | No | N/A | FR1 |
| Indicates the maximum average percentage of symbols during | | | | only |
| a certain evaluation period that can be scheduled for uplink | | | | |
| transmission so as to ensure compliance with applicable | | | | |
| electromagnetic energy absorption requirements provided by | | | | |
| regulatory bodies. The average percentage of uplink symbols | | | | |
| is specified in 6.2A.1.3 in TS 38101-1[2] and the capability | | | | |
| applies to the CA combinations listed in table 6.2A.1.3-1 in | | | | |
| TS 38101-1[2]. If the field is absent, UE shall work on power | | | | |
| class 2 regardless of UL duty cycle and may use P-MPR_{c} as | | | | |
| defined in 6.2.4 in TS 38101-1[2] if necessary. | | | | |
| Value n50 corresponds to 50%, value n60 corresponds to 60% | | | | |
| and so on. | | | | |

NOTE:
Specific targeted UL duty cycle percentage is not assumed if the field is absent.

and similarly for supplemental uplink (SUL), the power class of the band combination is not modified (still power class 2 (PC2)).

Device implementations of the “P-MPR method” for power class fallback using P-MPR to modify the power capability as described above typically use averaging of the transmission power to achieve desired long-term target levels. The maximum power is then reduced by P-MPR in case the actual duty cycle is too large for maintaining these levels. These levels and the averaging window lengths employed by the wireless device are implementation specific.

Changes of the P-MPRc can trigger aperiodic PHR if the P-MPR is greater than a network configurable threshold phr-Tx-PowerFactorChange (dB) (e.g., as described in 3GPP standards such as in, for example, 3GPP TS 38.321), since the last PHR occasion. Aperiodic PHR can also be triggered if the path loss change is greater than the same threshold.

For frequency range 2 (FR2) there is no power class/capability fallback concept (power classes are mapped to device types) but P-MPR is allowed for serving cells for mitigating MPE due to large duty cycles or any other reason for which this power reduction is allowed.

However, existing P-MPR in 3GPP standards does not provide a sufficient indication of the power class change from the wireless device side.

### SUMMARY

Some embodiments advantageously provide methods, systems, and apparatuses for power capability change reporting.

One or more embodiments provides a technical solution to combine the power class change reporting with a flexibility that accommodates the existing P-MPR reporting, into the PHR.

Use of the P-MPR for power capability fallback is enabled in the PHR in addition to that wireless device using ΔP_{powerclass} indication. Changes of the P-MPR due to power-capability fallback triggers an aperiodic PHR in the same way as does a ΔP_{powerclass} change for a serving cell or a band combination. Use of the P-bit may be enabled (for other reasons for application of P-MPR). The P-bit of the PHR is set for a serving cell if the wireless device is also applying (e.g., implementing) P-MPR (both for single- and multi-entry PH reporting).

According to one aspect of the present disclosure, a wireless device configured to determine a power capability modification, and transmit a power headroom report, PHR, where the PHR quantifies the power capability modification for a serving cell based on a first field and a second field included in the PHR.

According to some embodiments of this aspect, the first field corresponds to a power-capability change value, and the second field corresponds to a P-bit value in the PHR, wherein the P-bit value indicates whether power backoff is applied due to power management.

According to some embodiments of this aspect, the power capability modification corresponds to a power available in the wireless device for transmission.

According to some embodiments of this aspect, the first field and the second field indicate at least one of: a power capability change by step of power class reported as wireless device capability, or a power boosting status.

According to some embodiments of this aspect, the first field and the second field indicate at least one of: a power boosting status based on the first field being set to 11 and the second field being set to 0; or a reserved combination based on the first field being set to 00 and the second field being set to 1.

According to some embodiments of this aspect, the first field and the second field are configured to indicate one of a plurality of power capability change ranges based on the setting of the first field and the second field.

According to some embodiments of this aspect, the first field and the second field indicate one of: a first power capability change range of less than or equal to 3 dB and greater than 0 dB; a second power capability change range of less than or equal to 6 dB and greater than 3 dB; or a third power capability change range of greater than 6 dB.

According to some embodiments of this aspect, at least one of: the first power capability change range being indicated based on the first field being set to 01 and the second field being set to 1; the second power capability change range being indicated based on the first field being set to 10 and the second field being set to 1; or the third power capability change range being indicated based on the first field being set to 11 and the second field being set to 1.

According to some embodiments of this aspect, the wireless device is further configured to aperiodically trigger transmission of the PHR when the power capability changes more than a predetermined amount.

According to some embodiments of this aspect, the wireless device is further configured to transmit the PHR when a percentage of symbols in which the wireless device is scheduled for transmission in a period of time is greater than a predetermined threshold.

According to some embodiments of this aspect, the power capability modification is associated with a modification of the power capability within a current power class of the wireless device.

According to some embodiments of this aspect, the wireless device is further configured to receive a scheduling of resources, where the scheduling of resources is based at least on the PHR.

According to another aspect of the present disclosure, a method implemented by a wireless device is provided. A power capability modification is determined. A power headroom report, PHR is transmitted, where the PHR quantifies the power capability modification for a serving cell based on a first field and a second field included in the PHR.

According to some embodiments of this aspect, the first field corresponds to a power-capability change value; and the second field corresponds to a P-bit value in the PHR, wherein the P-bit value indicates whether power backoff is applied due to power management.

According to some embodiments of this aspect, the power capability modification corresponds to a power available in the wireless device for transmission.

According to some embodiments of this aspect, the first field and the second field indicate at least one of: a power capability change by step of power class reported as wireless device capability; or a power boosting status.

According to some embodiments of this aspect, the first field and the second field indicate at least one of: a power boosting status based on the first field being set to 11 and the second field being set to 0; or a reserved combination based on the first field being set to 00 and the second field being set to 1.

According to some embodiments of this aspect, the first field and the second field are configured to indicate one of a plurality of power capability change ranges based on the setting of the first field and the second field.

According to some embodiments of this aspect, the first field and the second field indicate one of: a first power capability change range of less than or equal to 3 dB and greater than 0 dB; a second power capability change range of less than or equal to 6 dB and greater than 3 dB; or a third power capability change range of greater than 6 dB.

According to some embodiments of this aspect, at least one of: the first power capability change range being indicated based on the first field being set to 01 and the second field being set to 1; the second power capability change range being indicated based on the first field being set to 10 and the second field being set to 1; or the third power capability change range being indicated based on the first field being set to 11 and the second field being set to 1.

According to some embodiments of this aspect, transmission of the PHR is aperiodically triggered when the power capability changes more than a predetermined amount.

According to some embodiments of this aspect, the PHR is transmitted when a percentage of symbols in which the wireless device is scheduled for transmission in a period of time is greater than a predetermined threshold.

According to some embodiments of this aspect, the power capability modification is associated with a modification of the power capability within a current power class of the wireless device.

According to some embodiments of this aspect, receiving a scheduling of resources is received, where the scheduling of resources is based at least on the PHR.

According to another aspect of the present disclosure, a network node in communication with a wireless device is provided. The network node is configured to: receive a power headroom report, PHR, where the PHR quantifies the power capability modification for a serving cell based on a first field and a second field included in the PHR, and perform at least one action based on the power capability modification.

According to some embodiments of this aspect, the first field corresponds to a power-capability change value, and the second field corresponds to a P-bit value in the PHR, wherein the P-bit value indicates whether power backoff is applied due to power management.

According to some embodiments of this aspect, the power capability modification corresponds to a power available in the wireless device for transmission.

According to some embodiments of this aspect, the first field and the second field indicate one of: a power capability change by step of power class reported as wireless device capability; or a power boosting status.

According to some embodiments of this aspect, the first field and the second field indicate one of: a power boosting status based on the first field being set to 11 and the second field being set to 0; or a reserved combination based on the first field being set to 00 and the second field being set to 1.

According to some embodiments of this aspect, the first field and the second field are configured to indicate one of a plurality of power capability change ranges based on the setting of the first field and the second field.

According to some embodiments of this aspect, the first field and the second field indicate one of: a first power capability change range of less than or equal to 3 dB and greater than 0 dB; a second power capability change range of less than or equal to 6 dB and greater than 3 dB; or a third power capability change range of greater than 6 dB.

According to some embodiments of this aspect, at least one of: the first power capability change range is indicated based on the first field being set to 01 and the second field being set to 1; the second power capability change range is indicated based on the first field being set to 10 and the second field being set to 1; or the third power capability change range is indicated based on the first field being set to 11 and the second field being set to 1.

According to some embodiments of this aspect, the at least one action corresponds to scheduling of resources for the wireless device.

According to some embodiments of this aspect, the power capability modification is associated with a modification of the power capability within a current power class of the wireless device.

According to some embodiments of this aspect, the at least one action comprises scheduling at least one resource for the wireless device.

According to another aspect of the present disclosure, a method implemented by a network node that is in communication with a wireless device is provided. A power headroom report, PHR is received where PHR quantifies the power capability modification for a serving cell based on a first field and a second field included in the PHR. At least one action is performed based on the power capability modification.

According to some embodiments of this aspect, the first field corresponds to a power-capability change value; and the second field corresponds to a P-bit value in the PHR, wherein the P-bit value indicates whether power backoff is applied due to power management.

According to some embodiments of this aspect, the power capability modification corresponds to a power available in the wireless device for transmission.

According to some embodiments of this aspect, the first field and the second field indicate one of: a power capability change by step of power class reported as wireless device capability; or a power boosting status.

According to some embodiments of this aspect, the first field and the second field indicate one of: a power boosting status based on the first field being set to 11 and the second field being set to 0; or a reserved combination based on the first field being set to 00 and the second field being set to 1.

According to some embodiments of this aspect, the first field and the second field are configured to indicate one of a plurality of power capability change ranges based on the setting of the first field and the second field.

According to some embodiments of this aspect, the first field and the second field indicate one of: a first power capability change range of less than or equal to 3 dB and greater than 0 dB; a second power capability change range of less than or equal to 6 dB and greater than 3 dB; or a third power capability change range of greater than 6 dB.

According to some embodiments of this aspect, at least one of: the first power capability change range is indicated based on the first field being set to 01 and the second field being set to 1; the second power capability change range is indicated based on the first field being set to 10 and the second field being set to 1; or the third power capability change range is indicated based on the first field being set to 11 and the second field being set to 1.

According to some embodiments of this aspect, the at least one action corresponds to scheduling of resources for the wireless device.

According to some embodiments of this aspect, the power capability modification is associated with a modification of the power capability within a current power class of the wireless device.

According to some embodiments of this aspect, the at least one action comprises scheduling at least one resource for the wireless device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a power class change from a high power class to a lower power class to trigger PHR;

FIG. 2 is a diagram of a power class change from a lower power class to a high power class to trigger PHR;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of another example process in a network node according to some embodiments of the present disclosure;

FIG. 11 is a flowchart of an example process in a wireless device according to some embodiments of the present disclosure;

FIG. 12 is a flowchart of another example process in a wireless device according to some embodiments of the present disclosure;

FIG. 13 is a diagram of a single entry PHR MAC CE according to some embodiments of the present disclosure;

FIG. 14 is a diagram of a multiple entry PHR MAC CE with the highest ServCellIndex of serving cell with configured uplink being less than 8 according to some embodiments of the present disclosure; and

FIG. 15 is a diagram of multiple entry PHR MAC CE with the highest ServCellIndex of serving cell with configured uplink being equal to or higher than 8 according to some embodiments of the present disclosure.

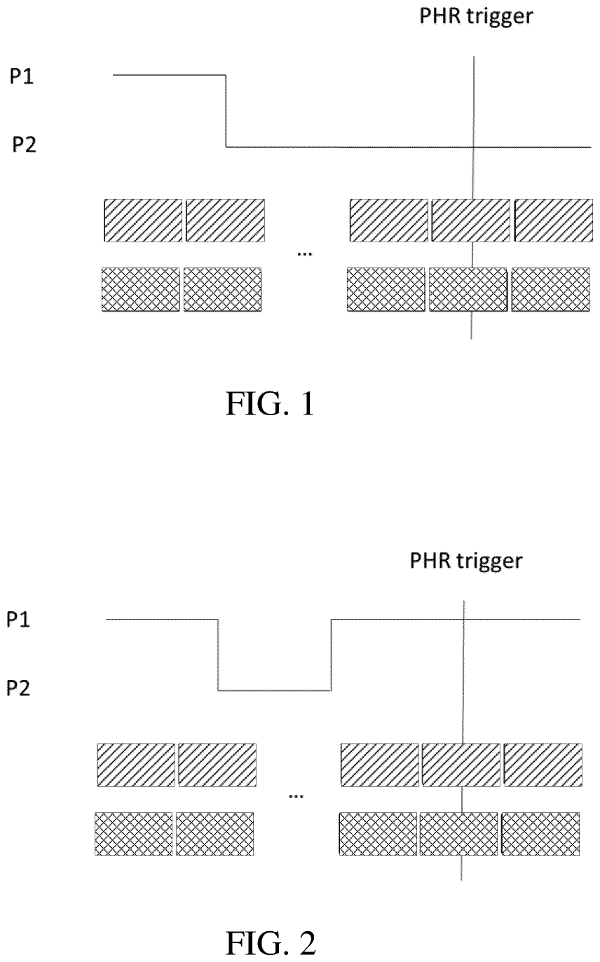

### DETAILED DESCRIPTION

As described above, the existing P-MPR defined in 3GPP standard does not provide a good indication of the power class change from the wireless device side.

Application of P-MPR for a serving cell is reported in the PHR by the P-bit for each applicable serving cell. However, for a UE (as an example of a wireless device) using the P-MPR for power-capability fallback rather than the ΔP_{powerclass}, the network node is not aware:
whether the P-MPR is limiting the reported P_{CMAX,f,c}(i) even if the P-bit is set or any other allowed power reduction of the configured maximum power—whether the P-MPR is due to the UL duty cycle of scheduled transmission by the network node for the connection concerned or due to user proximity detection or transmissions on another uncoordinated radio access technology
when a power capability change due to a large UL duty cycle has occurred
whether the power class of a carrier aggregation (CA), dual connectivity (DC) or SUL band combination has been modified due to the joint duty cycle of all uplink cells.

One proposed PHR scheme indicates the power class change but it is not giving the flexibility as indicated by the current P-MPR reporting.

Before describing in detail example embodiments, it is noted that the embodiments reside primarily in combinations of apparatus components and processing steps related to power capability change reporting. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

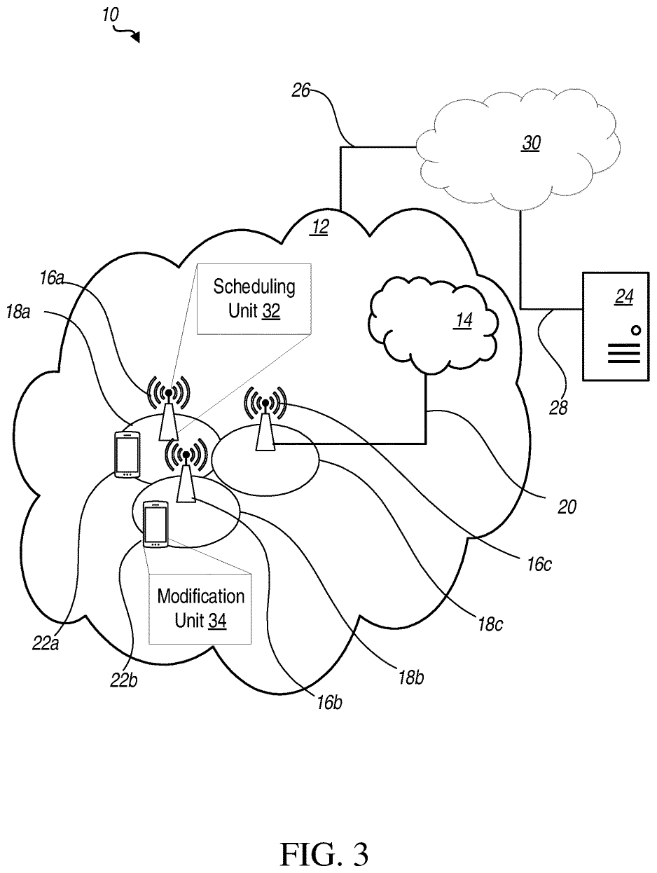

Some embodiments provide power capability change reporting using a power headroom report, as described herein. Referring again to the drawing figures, in which elements are referred to by reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a scheduling unit 32 which is configured to perform one or more network node 16 functions described herein such as with respect to power capability change reporting. A wireless device 22 is configured to include a modification unit 34 which is configured to perform one or more wireless device 22 functions as described herein such as with respect to power capability change reporting.

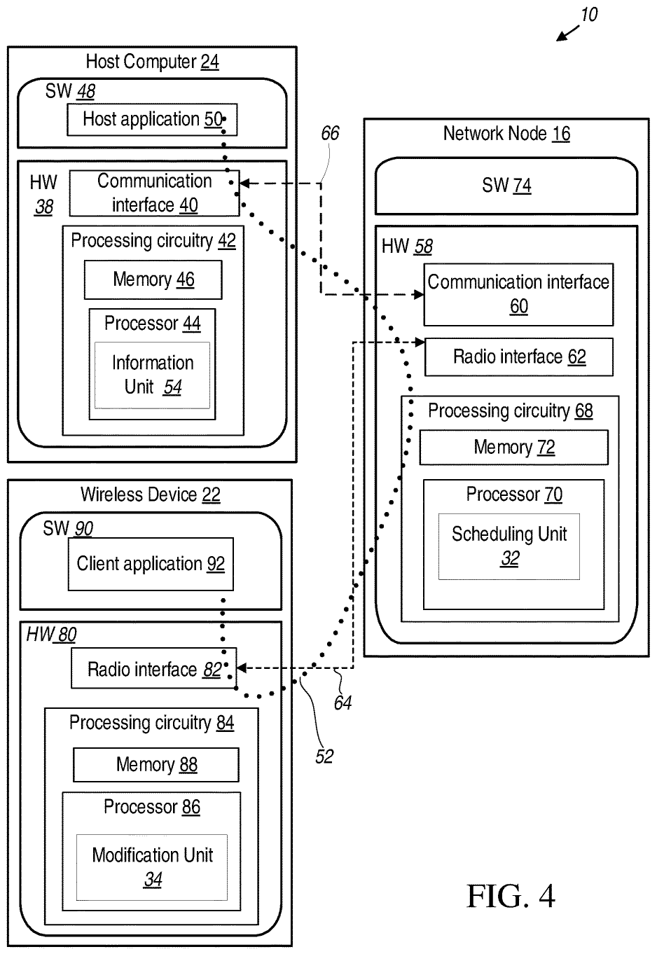

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of process, store, forward, relay, transmit, receive, analyze, etc. information related to power capability change reporting.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include scheduling unit 32 configured to perform one or more network node 16 functions described herein such as with respect to power capability change reporting.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a modification unit 34 configured to perform one or more wireless device 22 function as described herein such as with respect to power capability change reporting.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as scheduling unit 32, and modification unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

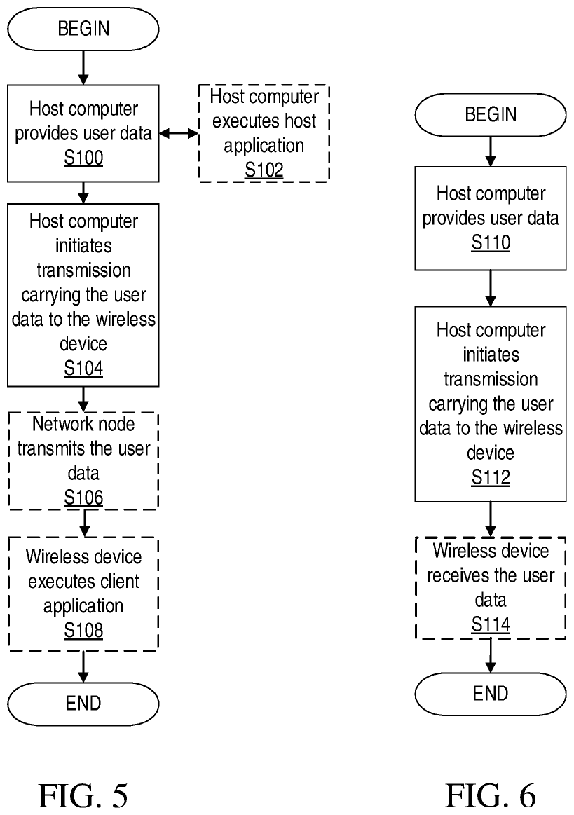

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

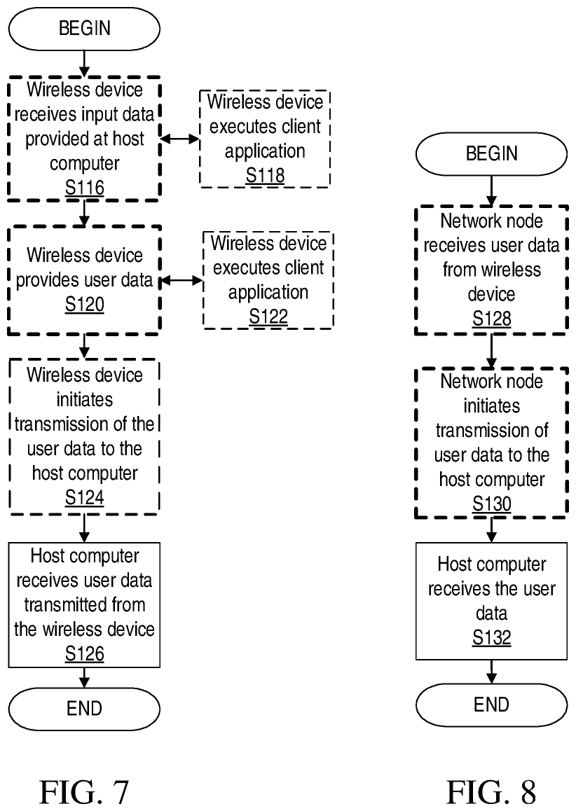

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

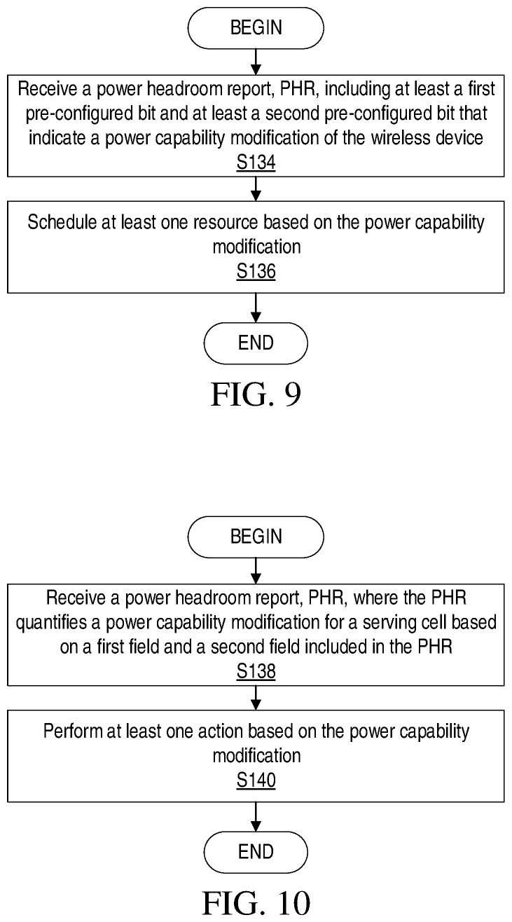

FIG. 9 is a flowchart of an example process in a network node 16 according to one or more embodiments of the present disclosure. One or more blocks described herein may be performed by one or more elements of network node 16 such as by one or more of processing circuitry 68 (including the scheduling unit 32), processor 70, radio interface 62 and/or communication interface 60. Network node 16 is configured to receive (Block S134) a power headroom report, PHR, including at least a first pre-configured bit and at least a second pre-configured bit that indicate a power capability modification of the wireless device 22, as described herein. Network node 16 is configured to schedule (Block S136) at least one resource based on the power capability modification, as described herein.

According to one or more embodiments, the at least first pre-configured bit corresponds to a power-capability change value, and the at least second pre-configured bit corresponds to a P-bit in the PHR, where, for example, the P-bit value indicates whether power backoff is applied due to power management.

According to one or more embodiments, the power capability modification corresponds to an actual power available at the wireless device 22, e.g., corresponds to the power available in the wireless device 22 for transmission.

According to one or more embodiments, the at least first pre-configured bit and the at least second pre-configured bit indicate at least one of a zero power capability modification, a power capability by change by step power class reported as wireless device capability, and a power boosting status.

According to one or more embodiments, the at least first pre-configured bit and the at least second pre-configured bit indicate at least one of: a zero power capability modification based on the at least first pre-configured bit corresponding to 00 and the at least second pre-configured bit corresponding to 0, a 3 dB power class change based on the at least first pre-configured bit corresponding to 01 and the at least second pre-configured bit corresponding to 0, a 6 dB power class change based on the at least first pre-configured bit corresponding to 10 and the at least second pre-configured bit corresponding to 0, a power boosting status based on the at least first pre-configured bit corresponding to 11 and the at least second pre-configured bit corresponding to 0, a reserved combination based on the at least first pre-configured bit corresponding to 00 and the at least second pre-configured bit corresponding to 1, a power capability change range of less than or equal to 3 dB and greater than 0 dB based on the at least first pre-configured bit corresponding to 01 and the at least second pre-configured bit corresponding to 1, a power capability change of less than or equal to 6 dB and greater than 3 dB based on the at least first pre-configured bit corresponding to 10 and the at least second pre-configured bit corresponding to 1, and a power capability change range of greater than 6 dB based on the at least first pre-configured bit corresponding to 11 and the at least second pre-configured bit corresponding to 1.

FIG. 10 is a flowchart of another example process in a network node 16 according to one or more embodiments of the present disclosure. One or more blocks described herein may be performed by one or more elements of network node 16 such as by one or more of processing circuitry 68 (including the scheduling unit 32), processor 70, radio interface 62 and/or communication interface 60. Network node 16 is configured to receive (Block S138) a power headroom report, PHR, where the PHR quantifies the power capability modification for a serving cell based on a first field and a second field included in the PHR, as described herein. Network node 16 is configured to perform (Block S140) at least one action based on the power capability modification.

According to some embodiments of this aspect, the first field corresponds to a power-capability change value, and the second field corresponds to a P-bit value in the PHR, wherein the P-bit value indicates whether power backoff is applied due to power management.

According to some embodiments of this aspect, the power capability modification corresponds to a power available in the wireless device for transmission.

According to some embodiments of this aspect, the first field and the second field indicate one of: a power capability change by step of power class reported as wireless device capability; or a power boosting status.

According to some embodiments of this aspect, the first field and the second field indicate one of: a power boosting status based on the first field being set to 11 and the second field being set to 0; or a reserved combination based on the first field being set to 00 and the second field being set to 1.

According to some embodiments of this aspect, the first field and the second field are configured to indicate one of a plurality of power capability change ranges based on the setting of the first field and the second field.

According to some embodiments of this aspect, the first field and the second field indicate one of: a first power capability change range of less than or equal to 3 dB and greater than 0 dB; a second power capability change range of less than or equal to 6 dB and greater than 3 dB; or a third power capability change range of greater than 6 dB.

According to some embodiments of this aspect, at least one of: the first power capability change range is indicated based on the first field being set to 01 and the second field being set to 1; the second power capability change range is indicated based on the first field being set to 10 and the second field being set to 1; or the third power capability change range is indicated based on the first field being set to 11 and the second field being set to 1.

According to some embodiments of this aspect, the at least one action corresponds to scheduling of resources for the wireless device 22.

According to some embodiments of this aspect, the power capability modification is associated with a modification of the power capability within a current power class of the wireless device 22.

According to some embodiments of this aspect, the at least one action comprises scheduling at least one resource for the wireless device 22.

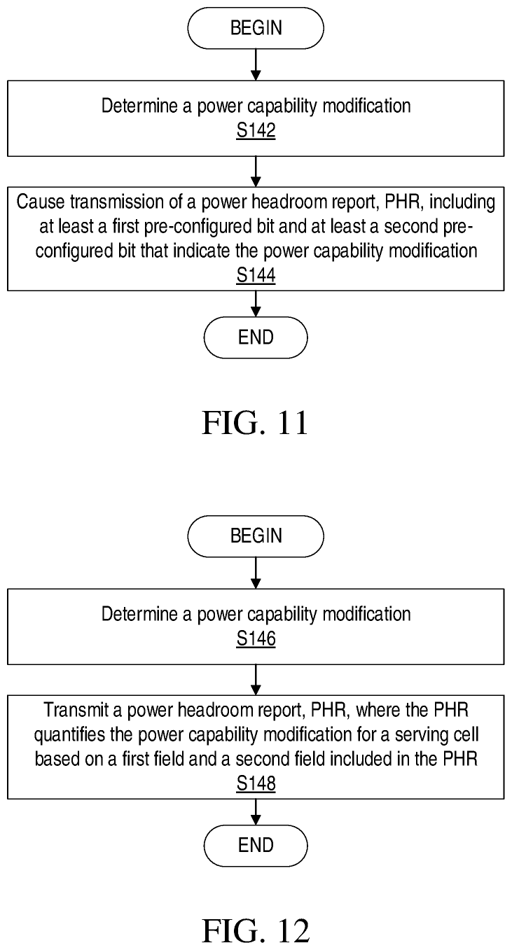

FIG. 11 is a flowchart of an example process in a wireless device 22 according to some embodiments of the present disclosure. One or more blocks described herein may be performed by one or more elements of wireless device 22 such as by one or more of processing circuitry 84 (including the modification unit 34), processor 86, radio interface 82 and/or communication interface 60. Wireless device 22 is configured to determine (Block S142) a power capability modification, as described herein. Wireless device 22 is configured to cause (Block S144) transmission of a power headroom report, PHR, including at least a first pre-configured bit and at least a second pre-configured bit that indicate the power capability modification, as described herein.

According to one or more embodiments, the at least first pre-configured bit corresponds to a power-capability change value; and the at least second pre-configured bit corresponds to a P-bit in the PHR, where, for example, the P-bit value indicates whether power backoff is applied due to power management.

According to one or more embodiments, the power capability modification corresponds to an actual power available at the wireless device.

According to one or more embodiments, the at least first pre-configured bit and the at least second pre-configured bit indicate at least one of: a zero power capability modification; a power capability by change by step power class reported as wireless device capability; and a power boosting status.

According to one or more embodiments, the at least first pre-configured bit and the at least second pre-configured bit indicate at least one of: a zero power capability modification based on the at least first pre-configured bit corresponding to 00 and the at least second pre-configured bit corresponding to 0; a 3 dB power class change based on the at least first pre-configured bit corresponding to 01 and the at least second pre-configured bit corresponding to 0; a 6 dB power class change based on the at least first pre-configured bit corresponding to 10 and the at least second pre-configured bit corresponding to 0; a power boosting status based on the at least first pre-configured bit corresponding to 11 and the at least second pre-configured bit corresponding to 0; a reserved combination based on the at least first pre-configured bit corresponding to 00 and the at least second pre-configured bit corresponding to 1; a power capability change range of less than or equal to 3 dB and greater than 0 dB based on the at least first pre-configured bit corresponding to 01 and the at least second pre-configured bit corresponding to 1; a power capability change of less than or equal to 6 dB and greater than 3 dB based on the at least first pre-configured bit corresponding to 10 and the at least second pre-configured bit corresponding to 1; and a power capability change range of greater than 6 dB based on the at least first pre-configured bit corresponding to 11 and the at least second pre-configured bit corresponding to 1.

According to one or more embodiments, the wireless device is further configured to receive a scheduling of resources for the wireless device, the scheduling of resources being based at least on the PHR.

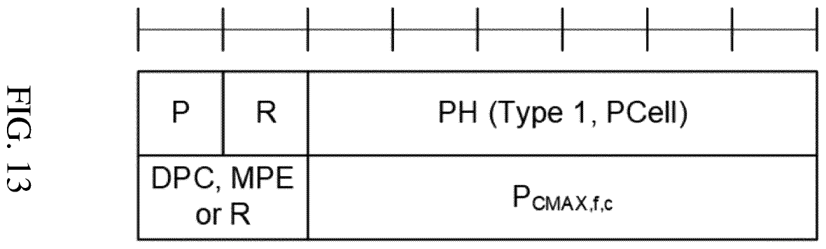

FIG. 12 is a flowchart of an example process in a wireless device 22 according to some embodiments of the present disclosure. One or more blocks described herein may be performed by one or more elements of wireless device 22 such as by one or more of processing circuitry 84 (including the modification unit 34), processor 86, radio interface 82 and/or communication interface 60. Wireless device 22 is configured to determine (Block S146) a power capability modification, as described herein. Wireless device 22 is configured to transmit (Block S148) a power headroom report, PHR, where the PHR quantifies the power capability modification for a serving cell based on a first field and a second field included in the PHR, as described herein.

According to some embodiments of this aspect, the first field corresponds to a power-capability change value, and the second field corresponds to a P-bit value in the PHR, wherein the P-bit value indicates whether power backoff is applied due to power management.

According to some embodiments of this aspect, the power capability modification corresponds to a power available in the wireless device 22 for transmission.

According to some embodiments of this aspect, the first field and the second field indicate at least one of: a power capability change by step of power class reported as wireless device capability, or a power boosting status.

According to some embodiments of this aspect, the first field and the second field indicate at least one of: a power boosting status based on the first field being set to 11 and the second field being set to 0; or a reserved combination based on the first field being set to 00 and the second field being set to 1.

According to some embodiments of this aspect, the first field and the second field are configured to indicate one of a plurality of power capability change ranges based on the setting of the first field and the second field.

According to some embodiments of this aspect, the first field and the second field indicate one of: a first power capability change range of less than or equal to 3 dB and greater than 0 dB; a second power capability change range of less than or equal to 6 dB and greater than 3 dB; or a third power capability change range of greater than 6 dB.

According to some embodiments of this aspect, at least one of: the first power capability change range being indicated based on the first field being set to 01 and the second field being set to 1; the second power capability change range being indicated based on the first field being set to 10 and the second field being set to 1; or the third power capability change range being indicated based on the first field being set to 11 and the second field being set to 1.

According to some embodiments of this aspect, the wireless device 22 is further configured to aperiodically trigger transmission of the PHR when the power capability changes more than a predetermined amount.

According to some embodiments of this aspect, the wireless device 22 is further configured to transmit the PHR when a percentage of symbols in which the wireless device 22 is scheduled for transmission in a period of time is greater than a predetermined threshold.

According to some embodiments of this aspect, the power capability modification is associated with a modification of the power capability within a current power class of the wireless device 22.

According to some embodiments of this aspect, the wireless device 22 is further configured to receive a scheduling of resources, where the scheduling of resources is based at least on the PHR.

Having described the general process flow of arrangements of the disclosure and having provided examples of hardware and software arrangements for implementing the processes and functions of the disclosure, the sections below provide details and examples of arrangements for power capability change reporting.

Some embodiments provide power capability change reporting. One or more network node 16 functions described herein may be performed by one or more of processing circuitry 68, processor 70, scheduling unit 32, etc. One or more wireless device 22 functions described herein may be performed by processing circuitry 84, processor 86, modification unit 34, etc.

### Prohibit Timer Applied for Power Capability Change

One or more embodiments applies to PHR where procedure in 3GPP standards such as, for example, 3GPP TS 38.321, is suggested to be changed as follows. This part in this section is an enhanced solution. Some of the new aspects of the present disclosure are indicated in bold and some changes to the 3GPP standard are indicated by underline.

### <Start of Change>

A Power Headroom Report (PHR) shall be triggered if any of the following events occur:
phr-ProhibitTimer expires or has expired and the path loss has changed more than phr-Tx-PowerFactorChange dB for at least one RS used as pathloss reference for one activated Serving Cell of any MAC entity of which the active DL BWP is not dormant BWP since the last transmission of a PHR in this MAC entity when the MAC entity has UL resources for new transmission;

### [First Version Reusing Phr-ProhibitTimer]

phr-ProhibitTimer expires or has expired and the power class has changed by at least phr-Tx-PowerClassChange dB or within phr-Tx-PowerCpabilityChangeRange for at least one activated Serving Cell of any MAC entity of which the active UL BWP is not dormant BWP since the last transmission of a PHR in this MAC entity when the MAC entity has UL resources for new transmission;
phr-ProhibitTimer expires or has expired and the power class has changed by at least phr-Tx-BandPowerClassChange dB or within phr-Tx-BandPowerCpabilityChangeRange for a configured band combination with at least one activated Serving Cell of any MAC entity of which active UL BWPs are not dormant BWP since the last transmission of a PHR in this MAC entity when the MAC entity has UL resources for new transmission;
   [Second Version with New Timer for Dpc Dpc-ProhibitTimer]
dpc-ProhibitTimer expires or has expired and the power class has changed by at least phr-Tx-PowerClassChange dB or within phr-Tx-PowerCpabilityChangeRange for at least one activated Serving Cell of any MAC entity of which the active UL BWP is not dormant BWP since the last transmission of a PHR in this MAC entity when the MAC entity has UL resources for new transmission;
dpc-ProhibitTimer expires or has expired and the power class has changed by at least phr-Tx-BandPowerClassChange dB or within phr-Tx-BandPowerCpabilityChangeRange for a configured band combiantion with at least one activated Serving Cell of any MAC entity of which active UL BWPs are not dormant BWP since the last transmission of a PHR in this MAC entity when the MAC entity has UL resources for new transmission;

### <End of Change>

### Single Entry Solution

For a single-entry PHR, the MPE is replaced by a power-class fallback value range indicated as D-PC together with the reserved P bit. This is an enhanced solution. Some new aspects of the present disclosure are indicated in bold with P=0 as the default value for reserved bit P.
P=0, DPC=00, zero power capability modification
P=0, DPC=01, 3 dB power class change
P=0, DPC=10, 6 dB power class change
P=0, DPC=11, power boosting status
P=1, DPC=00, reserved combination
P=1, DPC-01, power capability change range of <=3 dB and >0 dB
P=1, DPC=10, power capability change range of <=6 dB and >3 dB
P=1, DPC=11, power capability change range >6 dB

In one of the embodiments, it may be desirable to report the status when the wireless device 22 is able to transmit above its power class. Since, in some conditions, such boosting may not be assumed until the wireless device 22 reports that it is possible, the network node 16/network may need to refrain from scheduling according to the boosted power unless it has been reported as being possible by the wireless device 22. This may be contrasted with scheduling according to the wireless device 22's power class, where the wireless device 22 may report reduced power capability via positive values of DPC as an exception to the wireless device 22's normal operation. Since boosted power levels may not persist for long periods of time, it may be important that the wireless device 22 triggers a PHR when the available boosted power decreases or is no longer available as well as when it increases or becomes available.

Therefore, in an example embodiment, if a bit combination of ‘P=0, DPC=11’ is indicated by the wireless device 22, this means wireless device 22 can boost its power above its power class by a predetermined value, and P-MPR is not applied. When the boosted power is no longer available, the wireless device 22 reports another state that indicates that P-MPR is applied (i.e., associated with ‘P=1’) and/or that indicates DPC ranges including values greater than or equal to zero. In some embodiments, the predetermined boosting value may be fixed by 3GPP specifications, and may be for example 1 dB. In other embodiments, the predetermined boosting value is a value given in dB, and is signaled in wireless device capability to the network node 16.

Boosting the power may make it more difficult for the wireless device 22 to meet distortion requirements such as EVM and out of band emission requirements, etc. Therefore, in some embodiments, the power boost may only apply when the wireless device 22 transmits a lower order modulation than it is capable of when the power is not boosted. For example, the wireless device 22 may only support at most 16 QAM during boosting while it can support 64 QAM when transmitting at its power class. Similarly, the wireless device 22 may only transmit in PRBs away from the edge of the system bandwidth (i.e., ‘inner’ PRBs as defined by 3GPP standards such as in, for example, 3GPP TS 38.101) when the wireless device 22 is transmitting with boosted power.

In some embodiments, when the UE changes the amount of P-MPR it applies more than some predetermined amount, such as a network configurable threshold phr-Tx-PowerFactorChange (dB), or when the P-MPR the UE would report is different from a last reported value, this can trigger the UE to transmit the PHR containing the power capability modification aperiodically.

In some embodiments, the UE reports P-MPR in the PHR containing the power capability modification when the UE transmitting too frequently, such as when a percentage of symbols in which the UE is scheduled for transmission in a period of time is greater than some predetermined threshold.

Another embodiment is if P=1 and 00 is reported for the corresponding serving cell when any P-MPR is in use other than fallback when the “power fallback reporting” is configured, e.g., other purpose including transmission on Wi-Fi, etc. or proximity detection (user to close to the wireless device) or transmission on another RAT could cover any P-MPR use other than fallback when the “power fallback reporting” is configured, e.g., transmission on Wi-Fi, etc. or proximity detection (user to close to the wireless device 22).

One of the embodiments is applied to PHR in MAC CE with single entry, where procedure in 3GPP standards such as in, for example, 3GPP TS 38.321 is suggested to be changed as follows where some new aspect of the present disclosure are indicated in bold while some changes to the standard in accordance with the present disclosure are indicated in underline.

### <Start of Change>

### 6.1.3.8 Single Entry PHR MAC CE

The Single Entry PHR MAC CE is identified by a MAC subheader with LCID as specified in Table 6.2.1-2.

It has a fixed size and consists of two octets defined as follows (FIG. 13):
R: Reserved bit, set to 0;
Power Headroom (PH): This field indicates the power headroom level. The length of the field is 6 bits. The reported PH and the corresponding power headroom levels are shown in Table 6.1.3.8-1 below (the corresponding measured values in dB are specified in TS 38.133 [11]);
P: If mpe-Reporting-FR2 is configured and the Serving Cell operates on FR2, the MAC entity shall set this field to 0 if the applied P-MPR value, to meet MPE requirements, as specified in TS 38.101-2 [15], is less than P-MPR_00 as specified in TS 38.133 [11] and to 1 otherwise. If mpe-Reporting-FR2 is not configured or the Serving Cell operates on FR1, this field indicates whether power backoff is applied due to power management (as allowed by P-MPR_{c} as specified in TS 38.101-1 [14], TS 38.101-2 [15], and TS 38.101-3 [16]). The MAC entity shall set the P field to 1 if the corresponding P_{CMAX,f,c} field would have had a different value if no power backoff due to power management had been applied;
P_{CMAX,f,c}: This field indicates the P_{CMAX,f,c} (as specified in TS 38.213 [6]) used for calculation of the preceding PH field. The reported P_{CMAX,f,c} and the corresponding nominal UE (e.g., WD 22) transmit power levels are shown in Table 6.1.3.8-2 (the corresponding measured values in dBm are specified in TS 38.133 [11]);
MPE: If mpe-Reporting-FR2 is configured, and the Serving Cell operates on FR2, and if the P field is set to 1, this field indicates the applied power backoff to meet MPE requirements, as specified in TS 38.101-2 [15]. This field indicates an index to Table 6.1.3.8-3 and the corresponding measured values of P-MPR levels in dB are specified in TS 38.133 [11]. The length of the field is 2 bits. If mpe-Reporting-FR2 is not configured, or if the Serving Cell operates on FR1, or if the P field is set to 0, R bits are present instead.
D-PC: If power Capability ChangeReporting is configured, and the Serving Cell operates on FR1, this field indicates the applied power capability change as in step of power class or range between power class, as specified in TS 38.101-1 [14]. This field indicates an index to Table 6.1.3.8-4 and the corresponding power-class fallback level step or range in dB are specified in TS 38.133 [11]. The length of the field is 2 bits. If power Capability ChangeReporting is not configured, or if the Serving Cell operates on FR2, R bits are present instead.

TABLE 6.1.3.8-1
Power Headroom levels for PHR

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

TABLE 6.1.3.8-2
Nominal UE transmit power level for PHR

| P_{CMAX, f, c} | Nominal UE transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| 63 | PCMAX_C_63 |

TABLE 6.1.3.8-3
Effective power reduction for MPE P-MPR

| MPE | Measured P-MPR value |
|---|---|
| 0 | P-MPR_00 |
| 1 | P-MPR_01 |
| 2 | P-MPR_02 |
| 3 | P-MPR_03 |

TABLE 6.1.3.8-4
Power capability change value

| D-PC | Power-capability change value |
|---|---|
| 0 | D-PwrClass_00 |
| 1 | D-PwrClass_01 |
| 2 | D- PwrClass_02 |
| 3 | D-PwrClass_03 |

### <End of Change>

### Multiple Entries Solution

For a multi-entry PHR the MPE is replaced by a power-class fallback value range indicated as D-PC together with the reserved P bit.

For the band combination: the indication is the same as below, but we assume the P-MPR method will set this bit to “0” so PCMAX is not changed.

In one or more embodiments, the PCMAX is not changed (i.e., bit is set to “0”) by P-MPR, per serving cell, but the PCMAX may still be changed by ΔP_{powerclass,CA} which may affect the P-MPR value set per cell.

This is an enhanced solution. Bold indicates some new aspects of the present disclosure compared to a proposed solution, with P=0 as the default value for reserved bit P.
P=0, DPC=00, zero power capability modification
P=0, DPC=01, 3 dB power class change
P=0, DPC=10, 6 dB power class change
P=0, DPC=11, power boosting status
P=1, DPC=00, reserved combination
P=1, DPC=01, power capability change range of <=3 dB and >0 dB
P=1, DPC=10, power capability change range of <=6 dB and >3 dB
P=1, DPC=11, power capability change range >6 dB

Similar to the single entry solution above, if a bit combination of ‘P=0, DPC=11’ is indicated by the wireless device 22, this means the wireless device 22 can boost its power above its power class by a predetermined value, and P-MPR is not applied. When the boosted power is no longer available, the wireless device 22 reports another state that indicates that P-MPR is applied (i.e., associated with ‘P=1’) and/or that indicates DPC ranges including values greater than or equal to zero. In some embodiments, the predetermined boosting value is fixed in specifications and may be, for example, 1 dB. In other embodiments, the predetermined boosting value is a value given in dB, and is signaled in wireless device capability to the network.

Also similar to the single entry solution above, since boosting the power may make it more difficult for the wireless device 22 to meet distortion requirements, etc., constraints may be applied to transmissions with boosted power. In some embodiments, the power boost may only apply when the wireless device 22 transmits a lower order modulation than it is capable of when the power is not boosted. For example, the wireless device 22 may only support at most 16 QAM during boosting while it can support 64 QAM when transmitting at its power class. Similarly, the wireless device 22 may only transmit in PRBs away from the edge of the system bandwidth (i.e., ‘inner’ PRBs as defined by 3GPP standards such as, for example, 3GPP TS 38.101) when the wireless device 22 is transmitting with boosted power.

Another embodiment is if P=1 and 00 is reported for the corresponding serving cell, the P-MPR is used for other purpose (e.g., transmission on another RAT or proximity detection). This maintains the original functionality of the P-bit when power-class fallback reporting is configured.

For one of the embodiments is applied to PHR in MAC CE with single entry, where procedure in 3GPP standards such as in, for example, 3GPP TS 38.321 is suggested to be changed as follows, where the changes may be indicated in underline and some new aspect of the present invention are indicated in bold.

### <Start of Change>

### 6.1.3.9 Multiple Entry PHR MAC CE

The Multiple Entry PHR MAC CE is identified by a MAC subheader with LCID as specified in Table 6.2.1-2.

It has a variable size, and includes the bitmap, a Type 2 PH field and an octet containing the associated P_{CMAX,f,c} field (if reported) for SpCell of the other MAC entity, a Type 1 PH field and an octet containing the associated P_{CMAX,f,c} field (if reported) for the PCell. It further includes, in ascending order based on the ServCellIndex, one or multiple of Type X PH fields and octets containing the associated P_{CMAX,f,c} fields (if reported) for Serving Cells other than PCell indicated in the bitmap. X is either 1 or 3 according to TS 38.213 [6] and TS 36.213 [17].

The presence of Type 2 PH field for SpCell of the other MAC entity is configured by phr-Type2OtherCell with value true.

A single octet bitmap is used for indicating the presence of PH per Serving Cell when the highest ServCellIndex of Serving Cell with configured uplink is less than 8, otherwise four octets are used.

The MAC entity determines whether PH value for an activated Serving Cell is based on real transmission or a reference format by considering the configured grant(s) and downlink control information which has been received until and including the PDCCH occasion in which the first UL grant for a new transmission that can accommodate the MAC CE for PHR as a result of LCP as defined in clause 5.4.3.1 is received since a PHR has been triggered if the PHR MAC CE is reported on an uplink grant received on the PDCCH or until the first uplink symbol of PUSCH transmission minus PUSCH preparation time as defined in clause 7.7 of TS 38.213 [6] if the PHR MAC CE is reported on a configured grant.

For a band combination in which the UE does not support dynamic power sharing, the UE may omit the octets containing Power Headroom field and P_{CMAX,f,c} field for Serving Cells in the other MAC entity except for the PCell in the other MAC entity and the reported values of Power Headroom and P_{CMAX,f,c} for the PCell are up to UE implementation.

The PHR MAC CEs are defined as follows:
Cᵢ: This field indicates the presence of a PH field for the Serving Cell with ServCellIndex i as specified in TS 38.331 [5]. The Cᵢ field set to 1 indicates that a PH field for the Serving Cell with ServCellIndex i is reported. The Cᵢ field set to 0 indicates that a PH field for the Serving Cell with ServCellIndex i is not reported;
R: Reserved bit, set to 0;
V: This field indicates if the PH value is based on a real transmission or a-reference format. For Type 1 PH, the V field set to 0 indicates real transmission on PUSCH and the V field set to 1 indicates that a PUSCH reference format is used. For Type 2 PH, the V field set to 0 indicates real transmission on PUCCH and the V field set to 1 indicates that a PUCCH reference format is used. For Type 3 PH, the V field set to 0 indicates real transmission on SRS and the V field set to 1 indicates that an SRS reference format is used. Furthermore, for Type 1, Type 2, and Type 3 PH, the V field set to 0 indicates the presence of the octet containing the associated P_{CMAX,f,c} field and the MPE field, and the V field set to 1 indicates that the octet containing the associated P_{CMAX,f,c} field and the MPE field is omitted;
Power Headroom (PH): This field indicates the power headroom level. The length of the field is 6 bits. The reported PH and the corresponding power headroom levels are shown in Table 6.1.3.8-1 (the corresponding measured values in dB for the NR Serving Cell are specified in TS 38.133 while the corresponding measured values in dB for the E-UTRA Serving Cell are specified in TS 36.133 [12]);
P: If mpe-Reporting-FR2 is configured and the Serving Cell operates on FR2, the MAC entity shall set this field to 0 if the applied P-MPR value, to meet MPE requirements, as specified in TS 38.101-2 [15], is less than P-MPR_00 as specified in TS 38.133 and to 1 otherwise. If mpe-Reporting-FR2 is not configured or the Serving Cell operates on FR1, this field indicates whether power backoff is applied due to power management (as allowed by P-MPR_{c} as specified in TS 38.101-1 [14], TS 38.101-2 [15], and TS 38.101-3 [16]). The MAC entity shall set the P field to 1 if the corresponding P_{CMAX,f,c} field would have had a different value if no power backoff due to power management had been applied;
P_{CMAX,f,c}: If present, this field indicates the P_{CMAX,f,c} (as specified in TS 38.213 [6]) for the NR Serving Cell and the P_{CMAX,c} or P_{CMAX,c} (as specified in TS 36.213 [17]) for the E-UTRA Serving Cell used for calculation of the preceding PH field. The reported P_{CMAX,f,c} and the corresponding nominal UE transmit power levels are shown in Table 6.1.3.8-2 (the corresponding measured values in dBm for the NR Serving Cell are specified in TS 38.133 while the corresponding measured values in dBm for the E-UTRA Serving Cell are specified in TS 36.133 [12]);
MPE: If mpe-Reporting-FR2 is configured, and the Serving Cell operates on FR2, and if the P field is set to 1, this field indicates the applied power backoff to meet MPE requirements, as specified in TS 38.101-2 [15]. This field indicates an index to Table 6.1.3.8-3 and the corresponding measured values of P-MPR levels in dB are specified in TS 38.133 [11]. The length of the field is 2 bits. If mpe-Reporting-FR2 is not configured, or if the Serving Cell operates on FR1, or if the P field is set to 0, R bits are present instead.
D-PC-bc: If powerCapabilityChangeReporting is configured and the UE is configured with a band combination, this field indicates that the UE applies power capability change as in step of power class or range between power class for this band combination, as specified in TS 38.101-1 [15]. The length of the field is 2 bits. If powerCapabilityChangeReporting is not configured, R bits are present instead.

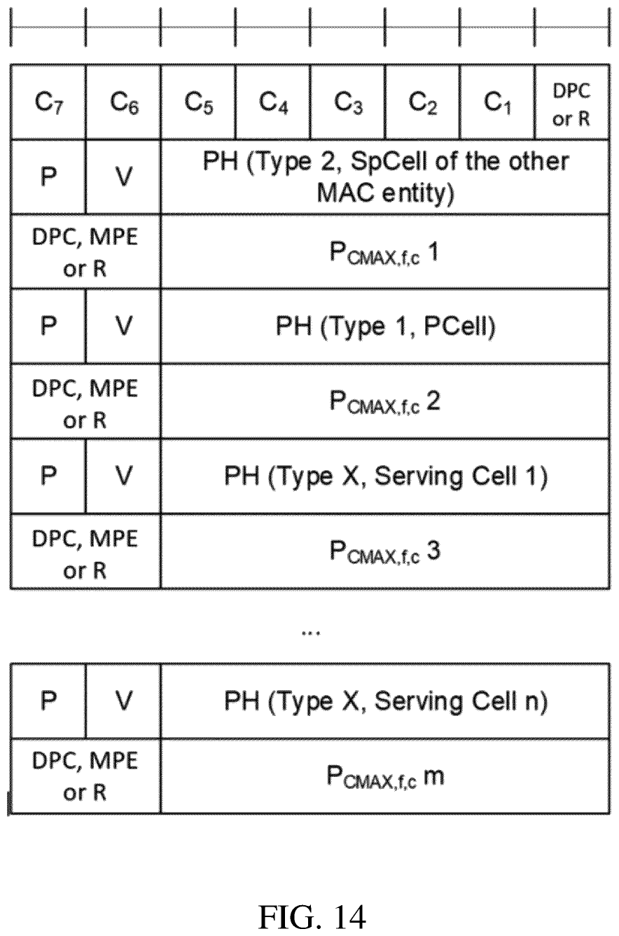

FIG. 14 is a diagram of multiple entry PHR MAC CE with the highest ServCellIndex of Serving Cell with configured uplink is less than 8.

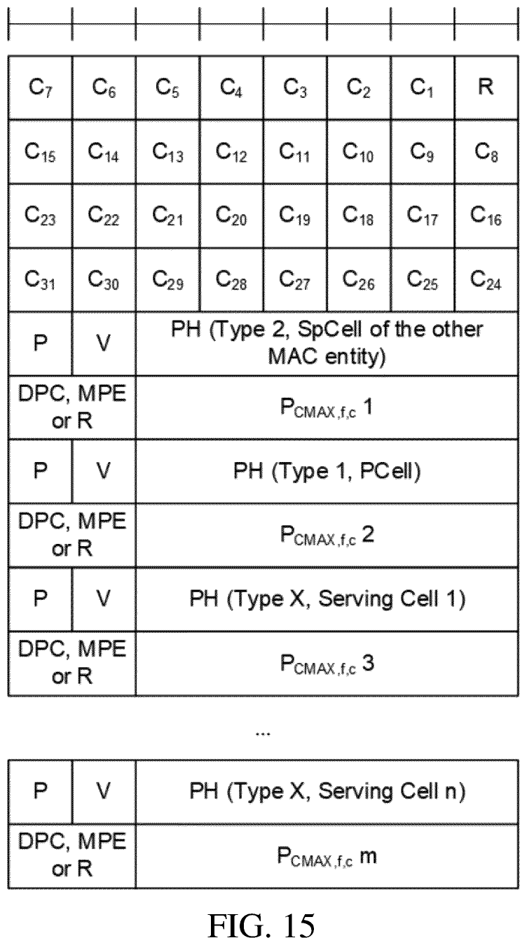

FIG. 15 is another diagram of multiple entry PHR MAC CE with the highest ServCellIndex of Serving Cell with configured uplink is equal to or higher than 8.

### <End of Change>

### Some Examples

Note: At least some new aspects of the present disclosure are indicated in bold below.

Example 1. A method implemented in a wireless device 22 that is configured to communicate with a network node 16, the method comprising:
determining a power capability modification from a first power capability to a second power capability among a plurality of power capabilities; and
reporting a power headroom report (PHR) including at least a first pre-configured bit (D-PC) and at least a second pre-configured bit (P bit), indicating the power capability modification.

Example 2. A method of Example 1, wherein the power capability modification corresponds to an actual power available at the wireless device 22.

Example 3. A method of Examples 1-2, wherein the combination of the first pre-configured bit and the second pre-configured bit indicating power capability modification includes at least one of the following,
zero power capability modification;
a power capability changed by step of power class reported as wireless device 22 capability;
a power capability changed by range between power class reported as wireless device 22 capability;
a power boosting status.

Example 4. A method of Examples 1-3, wherein the second pre-configured bit is the reserved bit P (e.g., P bit) that indicates the change either by step or by range.

Example 5. A method of Examples 1-4, wherein the power capability modification range corresponds to one of:
a ΔPower_class for a serving cell; and
a ΔPower_class_CA for a band combination.

Example 6. A method of Examples 1-5, wherein the combination of the first and second pre-configured bit indicate at least one of the following power capability modifications,
P=0, DPC=00, zero power capability modification;
P=0, DPC=01, 3 dB power class change;
P=0, DPC=10, 6 dB power class change;
P=0, DPC=11, power boosting status;
P=1, DPC=00, reserved combination;
P=1, DPC=01, power capability change range of <=3 dB and >0 dB;
P=1, DPC=10, power capability change range of <=6 dB and >3 dB;
P=1, DPC=11, power capability change range >6 dB.

Example 7. A method of Examples 1-6, wherein reporting ‘P=0, DPC-11, power boosting status’ indicates that wireless device 22 transmits the UL signals at a predetermined power above the power class according to at least one of the following
a limit on modulation order; and
a limit on occupied PRBs in the frequency domain.

### Some Additional Examples

Example A1. A network node 16 configured to communicate with a wireless device 22 (WD 22), the network node 16 configured to, and/or comprising a radio interface 62 and/or comprising processing circuitry 68 configured to:
receive a power headroom report, PHR, including at least a first pre-configured bit and at least a second pre-configured bit that indicate a power capability modification of the wireless device 22; and
schedule at least one resource based on the power capability modification.

Example A2. The network node 16 of Example A1, wherein the at least first pre-configured bit corresponds to a power-capability change value; and
the at least second pre-configured bit corresponds to a P-bit in the PHR.

Example A3. The network node 16 of Example A1, wherein the power capability modification corresponds to an actual power available at the wireless device 22.

Example A4. The network node 16 of Example A1, wherein the at least first pre-configured bit and the at least second pre-configured bit indicate at least one of:
a zero power capability modification;
a power capability by change by step power class reported as wireless device capability; and
a power boosting status.

Example A5. The network node 16 of Example A1, wherein the at least first pre-configured bit and the at least second pre-configured bit indicate at least one of:
a zero power capability modification based on the at least first pre-configured bit corresponding to 00 and the at least second pre-configured bit corresponding to 0;
a 3 dB power class change based on the at least first pre-configured bit corresponding to 01 and the at least second pre-configured bit corresponding to 0;
a 6 dB power class change based on the at least first pre-configured bit corresponding to 10 and the at least second pre-configured bit corresponding to 0;
a power boosting status based on the at least first pre-configured bit corresponding to 11 and the at least second pre-configured bit corresponding to 0;
a reserved combination based on the at least first pre-configured bit corresponding to 00 and the at least second pre-configured bit corresponding to 1;
a power capability change range of less than or equal to 3 dB and greater than 0 dB based on the at least first pre-configured bit corresponding to 01 and the at least second pre-configured bit corresponding to 1;
a power capability change of less than or equal to 6 dB and greater than 3 dB based on the at least first pre-configured bit corresponding to 10 and the at least second pre-configured bit corresponding to 1; and
a power capability change range of greater than 6 dB based on the at least first pre-configured bit corresponding to 11 and the at least second pre-configured bit corresponding to 1.

Example B1. A method implemented in a network node 16 that is configured to communicate with a wireless device 22, the method comprising:
receiving a power headroom report, PHR, including at least a first pre-configured bit and at least a second pre-configured bit that indicate a power capability modification of the wireless device 22; and
scheduling at least one resource based on the power capability modification

Example B2. The method of Example B1, wherein the at least first pre-configured bit corresponds to a power-capability change value; and
the at least second pre-configured bit corresponds to a P-bit in the PHR.

Example B3. The method of Example B1, wherein the power capability modification corresponds to an actual power available at the wireless device 22.

Example B4. The method of Example B1, wherein the at least first pre-configured bit and the at least second pre-configured bit indicate at least one of:
a zero power capability modification;
a power capability by change by step power class reported as wireless device capability; and
a power boosting status.

Example B5. The method of Example B1, wherein the at least first pre-configured bit and the at least second pre-configured bit indicate at least one of: a zero power capability modification based on the at least first pre-configured bit corresponding to 00 and the at least second pre-configured bit corresponding to 0;
a 3 dB power class change based on the at least first pre-configured bit corresponding to 01 and the at least second pre-configured bit corresponding to 0;
a 6 dB power class change based on the at least first pre-configured bit corresponding to 10 and the at least second pre-configured bit corresponding to 0;
a power boosting status based on the at least first pre-configured bit corresponding to 11 and the at least second pre-configured bit corresponding to 0;
a reserved combination based on the at least first pre-configured bit corresponding to 00 and the at least second pre-configured bit corresponding to 1;
a power capability change range of less than or equal to 3 dB and greater than 0 dB based on the at least first pre-configured bit corresponding to 01 and the at least second pre-configured bit corresponding to 1;
a power capability change of less than or equal to 6 dB and greater than 3 dB based on the at least first pre-configured bit corresponding to 10 and the at least second pre-configured bit corresponding to 1; and
a power capability change range of greater than 6 dB based on the at least first pre-configured bit corresponding to 11 and the at least second pre-configured bit corresponding to 1.

Example C1. A wireless device 22 (WD 22) configured to communicate with a network node 16, the WD 22 configured to, and/or comprising a radio interface 62 and/or processing circuitry 68 configured to:
determine a power capability modification; and
cause transmission of a power headroom report, PHR, including at least a first pre-configured bit and at least a second pre-configured bit that indicate the power capability modification.

Example C2. The WD 22 of Example C1, wherein the at least first pre-configured bit corresponds to a power-capability change value; and
the at least second pre-configured bit corresponds to a P-bit in the PHR.

Example C3. The WD 22 of Example C1, wherein the power capability modification corresponds to an actual power available at the wireless device 22.

Example C4. The WD 22 of Example C1, wherein the at least first pre-configured bit and the at least second pre-configured bit indicate at least one of:
a zero power capability modification;
a power capability by change by step power class reported as wireless device capability; and
a power boosting status.

Example C5. The WD 22 of Example C1, wherein the at least first pre-configured bit and the at least second pre-configured bit indicate at least one of:
a zero power capability modification based on the at least first pre-configured bit corresponding to 00 and the at least second pre-configured bit corresponding to 0;
a 3 dB power class change based on the at least first pre-configured bit corresponding to 01 and the at least second pre-configured bit corresponding to 0;
a 6 dB power class change based on the at least first pre-configured bit corresponding to 10 and the at least second pre-configured bit corresponding to 0;
a power boosting status based on the at least first pre-configured bit corresponding to 11 and the at least second pre-configured bit corresponding to 0;
a reserved combination based on the at least first pre-configured bit corresponding to 00 and the at least second pre-configured bit corresponding to 1;
a power capability change range of less than or equal to 3 dB and greater than 0 dB based on the at least first pre-configured bit corresponding to 01 and the at least second pre-configured bit corresponding to 1;
a power capability change of less than or equal to 6 dB and greater than 3 dB based on the at least first pre-configured bit corresponding to 10 and the at least second pre-configured bit corresponding to 1; and
a power capability change range of greater than 6 dB based on the at least first pre-configured bit corresponding to 11 and the at least second pre-configured bit corresponding to 1.

Example C6. The WD 22 of Example C1, wherein the processing circuitry 84 is further configured to receive a scheduling of resources for the wireless device 22, the scheduling of resources being based at least on the PHR.

Example D1. A method implemented in a wireless device 22 (WD 22) that is configured to communicate with a network node 16, the method comprising:
determining a power capability modification; and
causing transmission of a power headroom report, PHR, including at least a first pre-configured bit and at least a second pre-configured bit that indicate the power capability modification.

Example D2. The method of Example D1, wherein the at least first pre-configured bit corresponds to a power-capability change value; and
the at least second pre-configured bit corresponds to a P-bit in the PHR.

Example D3. The method of Example D1, wherein the power capability modification corresponds to an actual power available at the wireless device 22.

Example D4. The method of Example D1, wherein the at least first pre-configured bit and the at least second pre-configured bit indicate at least one of:
a zero power capability modification;
a power capability by change by step power class reported as wireless device capability; and
a power boosting status.

Example D5. The method of Example D1, wherein the at least first pre-configured bit and the at least second pre-configured bit indicate at least one of:
a zero power capability modification based on the at least first pre-configured bit corresponding to 00 and the at least second pre-configured bit corresponding to 0;
a 3 dB power class change based on the at least first pre-configured bit corresponding to 01 and the at least second pre-configured bit corresponding to 0;
a 6 dB power class change based on the at least first pre-configured bit corresponding to 10 and the at least second pre-configured bit corresponding to 0;
a power boosting status based on the at least first pre-configured bit corresponding to 11 and the at least second pre-configured bit corresponding to 0;
a reserved combination based on the at least first pre-configured bit corresponding to 00 and the at least second pre-configured bit corresponding to 1;
a power capability change range of less than or equal to 3 dB and greater than 0 dB based on the at least first pre-configured bit corresponding to 01 and the at least second pre-configured bit corresponding to 1;
a power capability change of less than or equal to 6 dB and greater than 3 dB based on the at least first pre-configured bit corresponding to 10 and the at least second pre-configured bit corresponding to 1; and
a power capability change range of greater than 6 dB based on the at least first pre-configured bit corresponding to 11 and the at least second pre-configured bit corresponding to 1.

Example D6. The method of Example D1, further comprising receiving a scheduling of resources for the wireless device 22, the scheduling of resources being based at least on the PHR.

Hence, one or more embodiments and/or examples described herein advantageously provides a technical solution to combine the power class change reporting with the flexibility that accommodates the existing P-MPR reporting, into the PHR. Itis one way to support the P-MPR based/smart power feature on top of power class fallback indication.

The wireless device 22 can report PHR with the practical power class indicated with the flexibility of P-MPR as a finer reporting of the power capability, which brings to the network node 16 side more granularity of the power capability from the wireless device 22 side, hence enhance the resource scheduling in a more efficient way, to improve the overall system performance.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

Abbreviation Explanation

| | |
|---|---|
| CE | Control Element |
| EN-DC | E-UTRA NR Dual Connectivity with E-UTRA |
| | connected to EPC |
| MAC | Media Access Control |
| MPE P-MPR | the power backoff to meet the MPE FR2 requirements |
| | for a Serving Cell operating on FR2 |
| MPR | Maximum Power Reduction |
| MR-DC | Multi-Radio Dual Connectivity |
| PHR | Power Headroom Reporting |
| RRC | Radio Resource Control |
| SRS | Sounding Reference Signal |
| UE | User Equipment |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-46. (canceled)

47. A method implemented by a wireless device, the method comprising:
determining a power capability modification; and
transmitting a power headroom report, PHR, the PHR quantifying the power capability modification for a serving cell based on a first field and a second field included in the PHR, the first field and the second field indicating at least one of:
a power capability change by step of power class reported as wireless device capability;
a power boosting status; or
a plurality of power capability change ranges based on the setting of the first field and the second field.

48. The method of claim 47, wherein the first field corresponds to a power-capability change value; and
the second field corresponds to a P-bit value in the PHR, wherein the P-bit value indicates whether power backoff is applied due to power management.

49. The method of claim 47, wherein the power capability modification corresponds to a power available in the wireless device for transmission.

50. The method of claim 47, wherein the first field and the second field indicate at least one of:
a power boosting status based on the first field being set to 11 and the second field being set to 0; or
a reserved combination based on the first field being set to 00 and the second field being set to 1.

51. The method of any one of claim 47 wherein the first field and the second field indicate one of:
a first power capability change range of less than or equal to 3 dB and greater than 0 dB;
a second power capability change range of less than or equal to 6 dB and greater than 3 dB; or
a third power capability change range of greater than 6 dB.

52. The method of claim 51, wherein at least one of:
the first power capability change range being indicated based on the first field being set to 01 and the second field being set to 1;
the second power capability change range being indicated based on the first field being set to 10 and the second field being set to 1; or
the third power capability change range being indicated based on the first field being set to 11 and the second field being set to 1.

53. The method of claim 47, further comprising aperiodically triggering transmission of the PHR when the power capability changes more than a predetermined amount.

54. The method of claim 47, further comprising transmitting the PHR when a percentage of symbols in which the wireless device is scheduled for transmission in a period of time is greater than a predetermined threshold.

55. The method of claim 47, wherein the power capability modification is associated with a modification of the power capability within a current power class of the wireless device.

56. The method of claim 47, further comprising receiving a scheduling of resources, the scheduling of resources being based at least on the PHR.

57. A wireless device configured to:
determine a power capability modification; and
transmit a power headroom report, PHR, the PHR quantifying the power capability modification for a serving cell based on a first field and a second field included in the PHR, the first field and the second field indicating at least one of:
a power capability change by step of power class reported as wireless device capability;
a power boosting status; or
a plurality of power capability change ranges based on the setting of the first field and the second field.

58. The wireless device of claim 57, wherein the first field corresponds to a power-capability change value; and
the second field corresponds to a P-bit value in the PHR, wherein the P-bit value indicates whether power backoff is applied due to power management.

59. A method implemented by a network node that is in communication with a wireless device, the method comprising:
receiving a power headroom report, PHR, the PHR quantifying a power capability modification for a serving cell based on a first field and a second field included in the PHR, the first field and the second field indicating at least one of:
a power capability change by step of power class reported as wireless device capability;
a power boosting status; or
a plurality of power capability change ranges based on the setting of the first field and the second field; and
perform at least one action based on the power capability modification.

60. The method of claim 59, wherein the first field corresponds to a power-capability change value; and
the second field corresponds to a P-bit value in the PHR, wherein the P-bit value indicates whether power backoff is applied due to power management.

61. The method of claim 59, wherein the power capability modification corresponds to a power available in the wireless device for transmission.

62. The method of claim 59, wherein the first field and the second field indicate one of:
a power boosting status based on the first field being set to 11 and the second field being set to 0; or
a reserved combination based on the first field being set to 00 and the second field being set to 1.

63. The method of claim 59, wherein the first field and the second field indicate one of:
a first power capability change range of less than or equal to 3 dB and greater than 0 dB;
a second power capability change range of less than or equal to 6 dB and greater than 3 dB; or
a third power capability change range of greater than 6 dB.

64. The method of claim 59, wherein at least one of:
the first power capability change range is indicated based on the first field being set to 01 and the second field being set to 1;
the second power capability change range is indicated based on the first field being set to 10 and the second field being set to 1; or
the third power capability change range is indicated based on the first field being set to 11 and the second field being set to 1.

65. The method of claim 59, wherein the at least one action corresponds to scheduling of resources for the wireless device.

66. The method of claim 59, wherein the power capability modification is associated with a modification of the power capability within a current power class of the wireless device.

67. A network node in communication with a wireless device, the network node configured to:
receive a power headroom report, PHR, the PHR quantifying a power capability modification for a serving cell based on a first field and a second field included in the PHR, the first field and the second field indicating at least one of:
a power capability change by step of power class reported as wireless device capability;
a power boosting status; or
a plurality of power capability change ranges based on the setting of the first field and the second field; and
perform at least one action based on the power capability modification.

68. The network node of claim 67, wherein the first field corresponds to a power-capability change value; and
the second field corresponds to a P-bit value in the PHR, wherein the P-bit value indicates whether power backoff is applied due to power management.
